(19) United States
(12) Patent Application Publication
(10) Pub. No.: US 2022/0136837 A1
(43) Pub. Date: May 5, 2022

(54) Global Path Planning Using Piecewise Sigmoid Curves

(71) Applicant: Huawei Technologies Co., Ltd., Shenzhen (CN)

(72) Inventors: Chand Aneesh Neeschal, Kanagawa (JP); Kebin Yuan, Shenzhen (CN)

(21) Appl. No.: 17/578,936

(22) Filed: Jan. 19, 2022

Related U.S. Application Data
(63) Continuation of application No. PCT/CN2019/096909, filed on Jul. 19, 2019.

(51) Int. Cl. G01C 21/20; G05D 1/02

(52) U.S. Cl. CPC G01C 21/206; G05D 1/0212; G05D 1/0274

(57) ABSTRACT

The field of the invention relates to robot motion and a global path plan for a robot. Global paths are planned using piecewise Sigmoid curves by determining an initial valid path for guiding a robot from a starting position to an ending position, dividing the initial valid path into a plurality of individual segments of the initial valid path, and fitting a separate Sigmoid curve respectively to each of the plurality of individual segments of the initial valid path based on parameters of at least one of smoothness and security to produce a piecewise Sigmoid curve path.

### CROSS-REFERENCE TO RELATED APPLICATIONS

This application is a continuation of International Application No. PCT/CN2019/096909, filed on Jul. 19, 2019. The disclosures of the aforementioned application are hereby incorporated by reference in its entirety.

### TECHNICAL FIELD

The field of the invention relates to robot motion and a global path plan for a robot.

### BACKGROUND

ROS navigation stack is a powerful tool for mobile robots to move reliably from place to place. The job of a navigation stack is to produce a safe path for a robot to navigate, by processing data from odometry, sensors, and a map of the environment.

Dynamics (e.g., the velocity and acceleration of a robot) are essential for local path planners, including dynamic window approach (DWA) and time elastic band (TEB). In the ROS navigation stack, a local path planner inputs sensor and odometry messages and outputs velocity commands that control the robot's motion. In ROS navigation, translational and rotational velocity and acceleration are required. Translational velocity (m/s) is the velocity when a robot is moving in a straight line, and rotational velocity (rad/s) is equivalent to angular velocity.

Three parameters determine the quality of the planned global path: cost factor, neutral cost, and lethal cost. If cost factor is higher, cost values will have a plateau around obstacles and the planner will then treat (for example) the whole width of a narrow hallway as equally undesirable and thus will not plan paths down the center. Extreme neutral cost values have the same effect. For lethal cost, setting it to a low value may result in failure to produce any path, even when a feasible path is obvious.

In mobile robotics, global paths may be planned for a mobile robot using the A*, Dijkstra, or Voronoi algorithms or their variants. However, there is a need to improve on conventional ill-defined paths for robot motion.

### SUMMARY

In accordance with an aspect of the present invention, global paths are planned using piecewise Sigmoid curves by determining an initial valid path for guiding a robot from a starting position to an ending position, dividing the initial valid path into a plurality of individual segments of the initial valid path, and fitting a separate Sigmoid curve respectively to each of the plurality of individual segments of the initial valid path based on parameters of at least one of smoothness and security to produce a piecewise Sigmoid curve path. By planning global paths in this manner, a robot navigating along the piecewise Sigmoid curve path may move continuously, smoothly, and with a reduced amount of starting and stopping of the onboard motors while avoiding and maintaining distance from obstacles in the environment.

This aspect may also include the method performed by the computer executing the instructions of the computer program, and an apparatus that performs the method.

The summary clause does not necessarily describe all necessary features of the embodiments of the present invention. The present invention may also be a sub-combination of the features described above.

### BRIEF DESCRIPTION OF THE DRAWINGS

FIG. 1 shows an exemplary hardware configuration for global path planning using piecewise sigmoid curves, according to an embodiment of the present invention.

FIG. 2 shows an exemplary method for global path planning using piecewise sigmoid curves, according to an embodiment of the present invention.

FIG. 3 shows an exemplary method of fitting Sigmoid curves to individual segments of an initial valid path to produce a piecewise Sigmoid curve path, according to an embodiment of the present invention.

FIG. 4 shows a map of an environment subjected to global path planning using piecewise sigmoid curves, according to an embodiment of the present invention.

FIG. 5 shows a path of piecewise sigmoid curves, according to an embodiment of the present invention.

FIG. 6 shows an example of a Sigmoid curve based on a Gompertz function, according to an embodiment of the present invention.

FIG. 7 shows a path of piecewise sigmoid curves illustrating a curve height adjustment, according to an embodiment of the present invention.

FIG. 8 shows a path of piecewise sigmoid curves illustrating curve starting point and curve sharpness adjustments, according to an embodiment of the present invention.

### DETAILED DESCRIPTION OF EMBODIMENTS

Hereinafter, example embodiments of the present invention will be described. The example embodiments shall not limit the invention according to the claims, and the combinations of the features described in the embodiments are not necessarily essential to the invention.

To plan a global path, robot motion control with well-defined, smooth, continuous, and non-stop paths may be obtained such that the robot can navigate from the start point to goal point in a smooth and continuous motion. The well-defined, smooth, continuous, and non-stop path may be acquired using piecewise well-defined mathematical shapes, such as Sigmoid curves, that allow a robot to navigate from goal point to start point in a single, smooth and continuous motion.

In mobile robotics, global paths may be planned for a mobile robot using the A*, Dijkstra, or Voronoi algorithms or their variants. However, all of these algorithms give paths that are either non-smooth or ill-defined paths, or paths that hug obstacles. Such non-optimal paths may lead to several other problems, such as (1) unnecessary stop-and-re-plan behavior which may result in robot motion that becomes non-continuous, (2) the robot opts not to navigate through a narrow area whereas in fact it is capable of doing so, i.e., the robot gets stuck, or (3) higher likelihood of obstacle collision since the robot may drift while following a path that hugs an obstacle, thus again leading to stop-and-re-plan behavior which may result in robot motion that becomes non-continuous.

The A* star path planning algorithm returns the shortest possible path from the goal point to destination point. Since it is the shortest path, the path hugs the environment and passes very close to obstacles in the environment (i.e., results in “hugging”). To prevent hugging, an inflation layer may be used as a workaround using an inflation radius, which increases the size of obstacles in the environment so that the robot does not hug as close to the environment. However, inflation layering may make a robot think a passageway is too narrow to pass through, whereas in fact the robot can pass through. Thus, inflation layer use may create a problem of the robot getting stuck in a narrow area when it is actually capable of passing through. In other words, since the inflation radius increases the size of obstacles in the environment, a narrow zone which the robot can otherwise pass safely through appears too narrow for the robot to pass through due to the inflation radius. Thus, the robot stops.

The A* star algorithm uses grids for planning. The coarser the grid, the less smooth the path is, thus paths that are not smooth are generated. Finer grids can be used to smooth such paths to a certain extent, but this may increase processing time. In addition, since the A* star algorithm gives the shortest possible path, the path may not be mathematically definable.

Using Dijkstra, paths may also not be well defined or smooth since Dijkstra paths are similar to A* paths in that A* is a special variant of Dijkstra.

The embodiments herein may provide improved and refined robot motion along a global path using a piecewise Sigmoid curve path based on an initial valid path returned by a planner, resulting in a smoother generated path. The resulting path may be well-defined, continuous and smooth, resulting in smooth and continuous robot motion while maximizing secure cost, establishing secure clearance of obstacles.

Embodiments herein may also provide adjustment that is much easier than ROS navigation stack systems. Also, as distances from obstacles in an environment are maximized, a robot may navigate continuously without any stop and go behavior.

Embodiments herein may avoid problems with A*, Dijkstra, or Voronoi path planning, such as ill-defined paths that are not smooth, hugging to obstacles leading to a greater likelihood of stop and re-plan behavior, and/or getting stuck. Individual Sigmoid curves may be best fit to individual segments of an initial valid path based on smoothness and security.

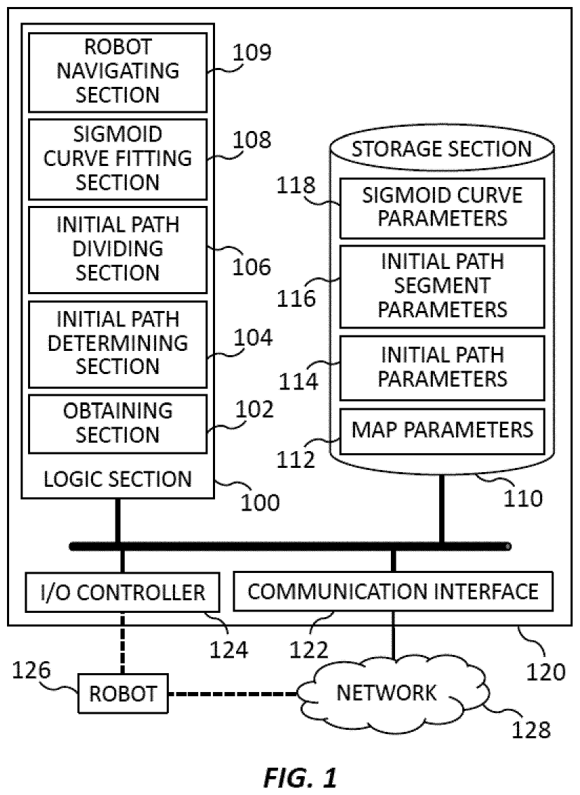

FIG. 1 shows an exemplary hardware configuration for global path planning using piecewise sigmoid curves, according to an embodiment of the present invention. The exemplary hardware configuration includes global path planning device 120, which communicates with network 128, and interacts with robot 126. Global path planning device 120 may be a host computer, such as a server computer or a mainframe computer that executes an on-premise application and hosts client computers that use it, in which case global path planning device 120 may not be directly connected to robot 126, but are connected through network 128. Global path planning device 120 may be a computer system that includes two or more computers. Global path planning device 120 may be a personal computer or a robot computer, such as a computer mounted on a robot, that executes an application for a user of global path planning device 120.

Global path planning device 120 includes a logic section 100, a storage section 110, a communication interface 122, and an input/output controller 124. Logic section 100 may be a computer program product including one or more computer readable storage mediums collectively storing program instructions that are executable by a processor or programmable circuitry to cause the processor or programmable circuitry to perform the operations of the various sections. Logic section 100 may alternatively be analog or digital programmable circuitry, or any combination thereof. Logic section 100 may be composed of physically separated storage or circuitry that interacts through communication. Storage section 110 may be a non-volatile computer-readable medium capable of storing non-executable data for access by logic section 100 during performance of the processes herein. Communication interface 122 reads transmission data, which may be stored on a transmission buffering region provided in a recording medium, such as storage section 110, and transmits the read transmission data to network 128 or writes reception data received from network 128 to a reception buffering region provided on the recording medium. Input/output controller 124 connects to various input and output units, such as those on robot 126, via a parallel port, a serial port, a keyboard port, a mouse port, a monitor port, and the like to accept commands and present information.

Output devices on robot 126 may include a display device, speaker, etc. Input devices on robot 126 may include a mouse, keyboard, etc. for receiving human input, and may also be a sensor for detecting various types of sensory data using cameras, accelerometers, GPS, etc. Such sensors may be mounted onto robot 126 that includes global path planning device 120, mounted onto another robot dedicated to environment mapping, mounted onto a structure that is static with respect to an environment that is the subject of mapping, or any combination.

Logic section 100 includes obtaining section 102, initial path determining section 104, initial path dividing section 106, and sigmoid curve fitting section 108. Storage section 110 includes map parameters 112, initial path parameters 114, initial path segment parameters 116, and sigmoid curve parameters 118.

Obtaining section 102 is the portion of logic section 100 that performs obtaining data from robot 126 and network 128, in the course of global path planning using sigmoid curves. Obtaining section 102 may store the data, such as map parameters 112, in storage section 110. Obtaining section 102 may include sub-sections for performing additional functions, as described in the flow charts below. Such sub-sections may be referred to by a name associated with their function.

Initial path determining section 104 is the portion of logic section 100 that determines initial valid paths in the course of global path planning using sigmoid curves. In doing so, initial path determining section 104 may process map parameters 112 to produce an initial valid path. Initial path determining section 104 may determine one or more initial valid paths for a given environment. Initial path determining section 104 may store each initial valid path in storage section 110 as initial path parameters 114. Initial path determining section 104 may include sub-sections for performing additional functions, as described in the flow charts below. Such sub-sections may be referred to by a name associated with their function.

Initial path dividing section 106 is the portion of logic section 100 that divides the initial valid path into a plurality of individual segments of the initial valid path. In doing so, initial path dividing section 106 may refer to initial path parameters 114, and store initial path segment parameters 116 in storage section 110. Initial path dividing section 106 may include sub-sections for performing additional functions, as described in the flow charts below. Such sub-sections may be referred to by a name associated with their function.

Sigmoid curve fitting section 108 is the portion of logic section 100 that fits a separate Sigmoid curve respectively to each of the plurality of individual segments of the initial valid path based on parameters of at least one of best smoothness and best security to produce a piecewise Sigmoid curve path. In doing so, sigmoid curve fitting section 108 may refer to initial path segment parameters 116, and store sigmoid curve parameters 118 in storage section 110. Sigmoid curve fitting section 108 may include sub-sections for performing additional functions, as described in the flow charts below. Such sub-sections may be referred to by a name associated with their function.

Robot navigating section 109 is the portion of logic section 100 that navigates a robot along the piecewise Sigmoid curve path. In doing so, robot navigating section 109 may refer to Sigmoid curve parameters 118, and operate motors of robot 126 accordingly. Robot navigating section 109 may include sub-sections for performing additional functions, as described in the flow charts below. Such sub-sections may be referred to by a name associated with their function.

In other embodiments, the global path planning device may be any other device capable of processing logical functions in order to perform the processes herein. The traffic flow inference device may not need to be connected to a network in environments where the input, output, and all information is directly connected. The logic section and the storage section need not be entirely separate devices, but may share one or more computer-readable mediums. For example, the storage section may be a hard drive storing both the computer-executable instructions and the data accessed by the logic section, and the logic section may be a combination of a central processing unit (CPU) and random access memory (RAM), in which the computer-executable instructions may be copied in whole or in part for execution by the CPU during performance of the processes herein.

In embodiments where the global path planning device is a computer, a program that is installed in the computer can cause the computer to function as or perform operations associated with apparatuses of the embodiments of the present invention or one or more sections (including modules, components, elements, etc.) thereof, and/or cause the computer to perform processes of the embodiments of the present invention or steps thereof. Such a program may be executed by a processor to cause the computer to perform certain operations associated with some or all of the blocks of flowcharts and block diagrams described herein.

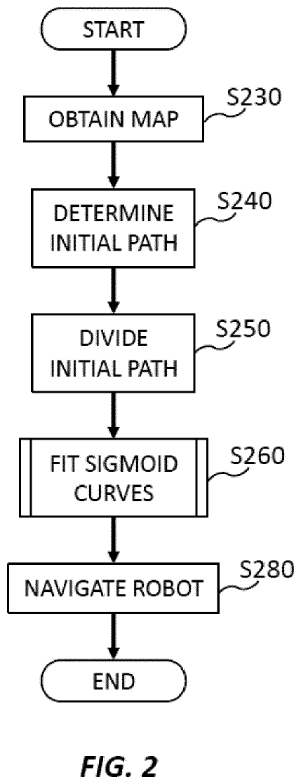

FIG. 2 shows an exemplary method for global path planning using piecewise sigmoid curves, according to an embodiment of the present invention. The operational flow may provide a method of global path planning using piecewise sigmoid curves.

At S230, an obtaining section, such as obtaining section 102, obtains a map of an environment including a starting position, an ending position, and at least one obstacle between the starting position and the ending position. The map may be compiled from sensory data from observing an environment and capturing sensory data thereof. The sensory data may include images, video, spatial data, etc. The obtaining section may obtain the map directly from a robot, such as robot 126, or through a network to which the input device is connected. The obtaining section may store the map as map parameters, such as map parameters 112, within storage section 110.

At S240, an initial path determining section, such as initial path determining section 104, determines an initial valid path for guiding a robot from the starting position to the ending position. The initial valid path may be acquired using a global path planner algorithm, such as A*, Dijkstra, etc., to search for and acquire an initial valid path, e.g., a shortest possible path, and form a search area based on an extension of the initial path. The obtaining section may store the initial valid path as initial path parameters, such as initial path parameters 114, within storage section 110.

At S250, an initial path dividing section, such as initial path dividing section 106, divides the initial valid path into a plurality of individual segments of the initial valid path. For example, the path may be divided based on the number and location of obstacles in the environment between the starting point and the ending point. The obtaining section may store the individual segments as initial path segment parameters, such as initial path segment parameters 116, within storage section 110.

At S260, a Sigmoid curve fitting section, such as Sigmoid curve fitting section 108, fits a separate Sigmoid curve respectively to each of the plurality of individual segments of the initial valid path based on parameters of at least one of smoothness and security to produce a piecewise Sigmoid curve path. A smoothness parameter may relate to the ability of a robot navigating along the Sigmoid curve to move continuously and reduce the starting and stopping of the onboard motors. A security parameter may relate to the ability of a robot navigating along the Sigmoid curve to avoid and maintain distance from obstacles in the environment. The piecewise Sigmoid curve path is piece-wise fit such that the initial point and direction of each subsequent Sigmoid curve coincides with the final point and direction of each previous Sigmoid curve.

At S280, a robot navigating section, such as robot navigating section 109, navigates a robot along the piecewise Sigmoid curve path. For example, robot navigating section operates motors of a robot, such as robot 126, to navigate the robot along the piecewise Sigmoid curve path. While navigating, robot navigating section may refer to sensory data in order to verify that the robot is navigating along the Sigmoid wise curve.

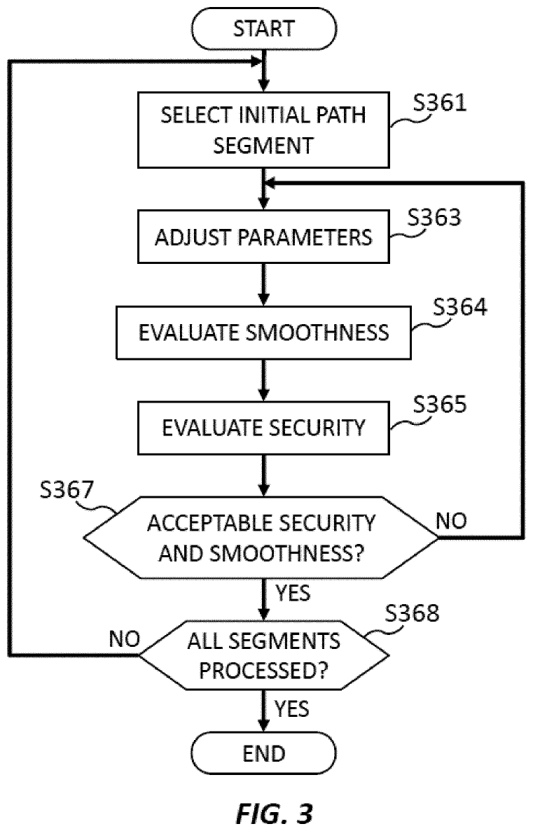

FIG. 3 shows an exemplary method of fitting Sigmoid curves to individual segments of an initial valid path to produce a piecewise Sigmoid curve path, according to an embodiment of the present invention. The operations within this operational flow may be performed by a Sigmoid curve fitting section, such as Sigmoid curve fitting section 108, or a correspondingly named sub-section thereof.

At S361, an initial path segment selecting section, such as Sigmoid curve fitting section 108 or a sub-section thereof, selects an initial path segment among the initial path segments. As iterations of the operational flow for global path planning proceed, only previously unselected initial path segments may be selected at S361, to ensure that each initial path segment is processed. For example, initial path segment selecting section may select the initial path segments in order from the starting position to the ending position.

At S363, a parameter adjusting section, such as Sigmoid curve fitting section 108 or a sub-section thereof, adjusts at least one of a curve height parameter, a curve start position parameter, a curve sharpness parameter, and a length parameter of a Sigmoid curve occupying the space of the selected initial path segment.

A desired path may be defined as a combination of several sigmoid curves,

$$path = {\sum }_{i = 1}^{n} S ( {t}_{i}^{start} , {a}_{i} , {b}_{i} , {c}_{i} , {t}_{i}^{end} ) \qquad EQ . 1$$

where adjacent curves are connected and subject to the following constraints

$${t}_{1}^{start} = {x}^{start} , {t}_{n}^{end} = {x}^{end} , {t}_{i + 1}^{start} = {t}_{i}^{end} \qquad EQ . 2$$

where t^{start} and t^{end} are the boundaries of a sigmoid curve i, and x^{start} and x^{end} are the positions that a piecewise Sigmoid curve path including n Sigmoid curves begins and ends.

At S364, a smoothness evaluating section, such as Sigmoid curve fitting section 108 or a sub-section thereof, evaluates a smoothness of the Sigmoid curve occupying the space of the selected initial path segment. For example, the smoothness evaluating section may evaluate the ability of a robot navigating along the Sigmoid curve to move continuously and the amount of starting and stopping of the onboard motors. A smooth term (Jₛₘₒₒₜₕ) may be realized by setting limitation to the maximal slope of the path function, that is

$$max ( \frac{{d}_{path ( i )}}{dt} ) \leq {C}_{i} \qquad EQ . 3$$

where dₚₐₜₕ₍ᵢ₎/dt is the slope of the path and Cᵢ is the desired maximum slope.

At S365, a security evaluating section, such as Sigmoid curve fitting section 108 or a sub-section thereof, evaluates a security of the Sigmoid curve occupying the space of the selected initial path segment. For example, the security evaluating section may evaluate ability of a robot navigating along the Sigmoid curve to avoid and maintain distance from obstacles in the environment. A secure term LT secure) may be realized by setting limitation to the distance difference between the left obstacle clearance and the right obstacle clearance, defined as

$${J}_{secure} = - {\sum }_{j = 1}^{k} \vert {d}_{j} - 2 * path ( j ) \vert \qquad EQ . 4$$

where dⱼ is the total available clearance of an obstacle j, and path(j) is the distance of the path from the obstacle, for each of obstacles 1 through k.

At S368, a Sigmoid curve fitting section, such as Sigmoid curve fitting section 108 or a sub-section thereof, determines whether the selected initial path segment has an acceptable security and smoothness, based on the evaluations at S364 and S365. To find the best-fit Sigmoid curve, a ‘cost’ function may be applied. A ‘cost’ function J may then be maximized and applied within a search area around an initial valid path segment to obtain parameters of an improved path. The cost function J is defined as:

$$J = {J}_{smooth} + {J}_{secure} \qquad EQ . 5$$

If the selected initial path segment has an acceptable security and smoothness, then the operational flow proceeds to S368. If the selected initial path segment has an acceptable security and smoothness, then the operational flow returns to S363, to re-adjust at least one of a curve height parameter, a curve start position parameter, a curve sharpness parameter, and a length parameter of a Sigmoid curve occupying the space of the selected initial path segment. As iterations of S363 to S365 of the operational flow proceed, each Sigmoid curve may be adjusted based on these terms to arrive at a final smooth and secure global path.

At S368, a Sigmoid curve fitting section, such as Sigmoid curve fitting section 108 or a sub-section thereof, determines whether all of initial path segments have been processed by the Sigmoid curve fitting section. If any initial path segments remain unprocessed, then the operational flow returns to S361, where initial path segment is selected for processing. If no initial path segments remain unprocessed, then the operational flow ends.

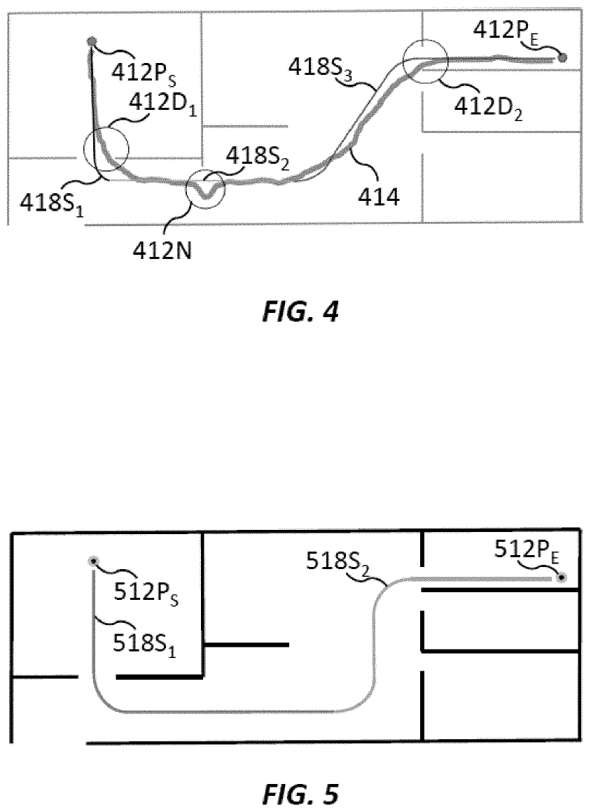

FIG. 4 shows a map of an environment subjected to global path planning using piecewise sigmoid curves, according to an embodiment of the present invention. A piecewise Sigmoid curve path includes three Sigmoid curves 418S₁, 418S₂, and 418S₃ defining a single, smooth, and continuous path from starting position 412P_{S} to ending position 412P_{E}.

In particular, as shown in FIG. 4, an initial valid path 414 was acquired using a global path planner algorithm, such as A*, Dijkstra, etc., to search for and determine an initial valid path, e.g., a shortest possible path, and form a search area based on an extension of the initial path. Along the path from starting position 412P_{S} to ending position 412P_{E}, obstacles, such as doorway 412D₁, narrow hallway 412N, and doorway 412D₂ are encountered.

For this environment, initial valid path 414 was prepared for piece-wise fitting by dividing the unsmooth, initial valid path into individual segments, such that the individual segments could be joined at midpoints between the obstacles (e.g., midway between doorway 412D₁, narrow hallway 412N, and doorway 412D₂). More specifically, initial valid path 414 was divided into three segments. A first segment of initial valid path 414 includes a Sigmoid curve fit through doorway 412D₁. A second segment of initial valid path 414 includes a Sigmoid curve fit through narrow hallway 412N, and a third segment of initial valid path 414 includes a Sigmoid curve fit through a central region and doorway 412D₂.

Each of the Sigmoid curves 418S₁, 418S₂, and 418S₃ were adjusted to an acceptable level of security and smoothness. Due to the adjustments, Sigmoid curve 418S₁ has increased clearance through doorway 412D₁ without sacrificing smoothness; Sigmoid curve 418S₂ has increased smoothness through narrow hallway 412N while avoiding unnecessary security; and Sigmoid curve 418S₃ has increased clearance through doorway 412D₂ without sacrificing smoothness.

FIG. 5 shows a comparative example of a path of piecewise Sigmoid curves, according to an embodiment of the present invention. In FIG. 5, only two Sigmoid curves, 518S₁ and 518S₂ form the global path from starting position 512P_{S} to ending position 512P_{E}. In comparing the piecewise Sigmoid curve paths in FIG. 4 and FIG. 5, note how the path shown in the central region of FIG. 5 appears sub-optimal. For example, a person walking the path would have taken a straighter path to the doorway in the upper right corner of FIG. 5. This could be due to sub-optimal selection of the number of Sigmoid curves, sub-optimal dividing of the initial valid path, or perhaps starting without an initial valid path. Without use of the initial valid path prior to fitting Sigmoid curves, the path through the central region of FIG. 5 becomes extended and unnatural, leading to sub-optimal smoothness.

After the initial valid path was determined and divided into segments, the individual segments of the initial valid path were then piece-wise fit into a well-defined mathematical shape, such as Sigmoid curves. A Sigmoid curve is, generally speaking, a mathematically-defined ‘S’ shaped curve that may extend out to be a straight line at one extreme, and be a step-shape with rounded corners at the other extreme.

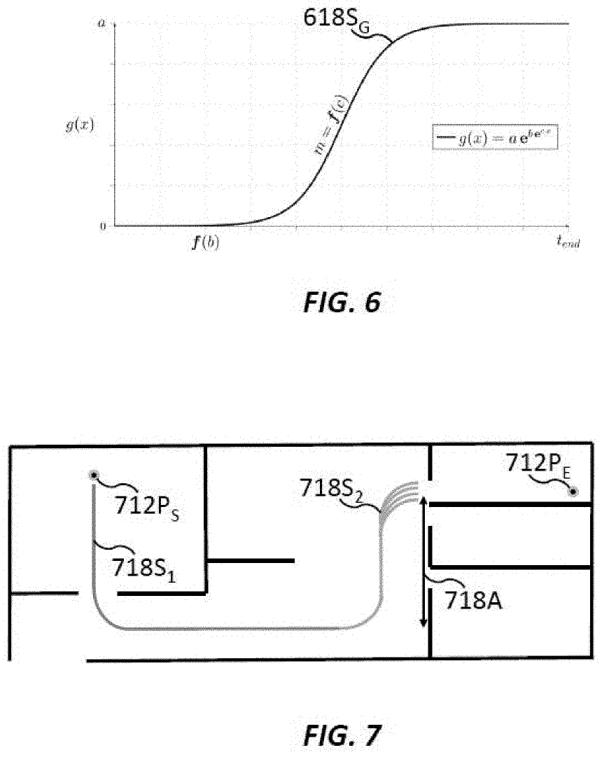

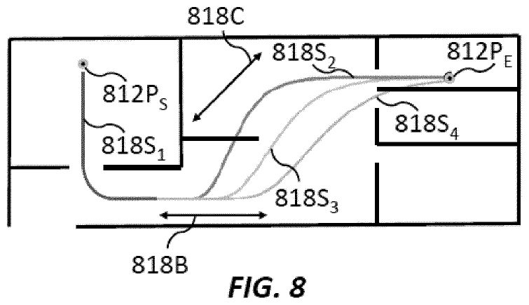

FIG. 6 shows an example of a Sigmoid curve based on a Gompertz function, according to an embodiment of the present invention. A Gompertz Sigmoid curve, is a well-defined mathematical function. In non-parametric form, the Gompertz Sigmoid curve is represented as:

$$g ( x ) = {ae}^{{be}^{cx}} \qquad EQ . 6$$

and in parametric form, the Gompertz Sigmoid curve is represented as:

$$\hat{g} ( t ) = 〈 t , {ae}^{{be}^{ct}} 〉 \qquad EQ . 7$$

The parameters a, b, c and t_end are adjusted to fit a Gompertz function to each of the individual segments of the initial valid path. The parameters (a, b, c, t_end) of each Gompertz function are adjusted during global path planning to maximize clearances from obstacles of a given individual segment of an initial valid path, and to increase smoothness.

In the Gompertz Sigmoid curve, a defines the height of a curve [a>0], b defines the position at which the curve is started [b<0], c defines the sharpness of the curve (i.e. sharp turn or smooth turn) [c<0], and t_end, which appears in the parametric form of the equation, defines the length of the curve.

In addition to the Gompertz Sigmoid curve, any type of Sigmoid curve can be used as well in the same way. Parameters a, b, and c can be added to the general equations of other Sigmoid curves to obtain similar behavior. The parameters a, b, and c can be adjusted to optimize a piecewise Sigmoid curve path. For instance, the Sigmoid curve may be a Logistic function:

$$f ( x ) = \frac{1}{1 + {e}^{- x}} , \qquad EQ . 8$$

a Hyperbolic tangent:

$$f ( x ) = tanh x = \frac{{e}^{x} - {e}^{- x}}{{e}^{x} + {e}^{- x}} , \qquad EQ . 9$$

an Arctangent function:

$$f ( x ) = arctan x , \qquad EQ . 10$$

a Gudermannian function:

$$f ( x ) = gd ( x ) = {\int }_{0}^{x} \frac{1}{cosh t} dt = 2 tanh ( arctan ( \frac{x}{2} ) ) , \qquad EQ . 11$$

an Error function:

$$f ( x ) = erf ( x ) = \frac{2}{\sqrt{π}} {\int }_{0}^{x} {e}^{- {t}^{2}} dt , \qquad EQ . 12$$

a Generalized logistic function:

$$f ( x ) = {( 1 + {e}^{- x} )}^{- α} , α > 0 , \qquad EQ . 13$$

a Smoothstep function:

$$f ( x ) = \{ \begin{matrix}\frac{{\int }_{0}^{x} {( 1 - {u}^{2} )}^{N} du}{{\int }_{0}^{1} {( 1 - {u}^{2} )}^{N} du } , & \vert x \vert \leq 1 \\ sgn ( x ) , & \vert x \vert \leq 1\end{matrix} N \geq 1 , \qquad EQ . 14$$

or even an Algebraic function:

$$f ( x ) = \frac{x}{\sqrt{1 + {x}^{2}}} . \qquad EQ . 15$$

For instance, consider a Logistic function Sigmoid curve. By introducing parameters a, b, and c to the Logistic function, the Logistic function equation becomes:

$$f ( x ) = a \frac{1}{1 + {be}^{- cx}} , \qquad EQ . 16$$

In this way, adjustment of the Logistic function equation behaves just like adjustment of the Gompertz Sigmoid curve, and thus can be adjusted in the same way. As another example, by introducing the a, b, and c parameters into the Arctangent function results in the following equation:

$$f ( x ) = a arctan ( {b}^{cx} ) . \qquad EQ . 17$$

Other Sigmoid curve functions can be made similarly adjustable by introducing a, b, and c parameters appropriately. For completeness, it should be understood that a Gompertz Sigmoid curve and other Sigmoid curve functions can also be used to represent straight lines so that it can be used for generating straight line paths for a robot simply by setting parameter c to be zero.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

Unless the context clearly requires otherwise, throughout the description and the claims, references are made herein to routines, subroutines, and modules. Generally it should be understood that a routine is a software program executed by computer hardware and that a subroutine is a software program executed within another routine. However, routines discussed herein may be executed within another routine and subroutines may be executed independently, i.e., routines may be subroutines and vice versa. As used herein, the term “module” (or “logic”) may refer to, be part of, or include an Application Specific Integrated Circuit (ASIC), a System on a Chip (SoC), an electronic circuit, a programmed programmable circuit (such as, Field Programmable Gate Array (FPGA)), a processor (shared, dedicated, or group) and/or memory (shared, dedicated, or group) or in another computer hardware component or device that execute one or more software or firmware programs or routines having executable machine instructions (generated from an assembler and/or a compiler) or a combination, a combinational logic circuit, and/or other suitable components with logic that provide the described functionality. Modules may be distinct and independent components integrated by sharing or passing data, or the modules may be subcomponents of a single module, or be split among several modules. The components may be processes running on, or implemented on, a single computer, processor or controller node or distributed among a plurality of computer, processor or controller nodes running in parallel, concurrently, sequentially or a combination.

Various embodiments of the present invention may be described with reference to flowcharts and block diagrams whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable media, and/or processors supplied with computer-readable instructions stored on computer-readable media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A method comprising:
determining an initial valid path for guiding a robot from a starting position to an ending position;
dividing the initial valid path into a plurality of individual segments of the initial valid path; and
fitting a separate Sigmoid curve respectively to each of the plurality of individual segments of the initial valid path based on parameters of at least one of smoothness and security to produce a piecewise Sigmoid curve path.

2. The method of claim 1, wherein: the fitting includes adjusting a curve height parameter, a curve start position parameter, a curve sharpness parameter, or a length parameter of each Sigmoid curve.

3. The method of claim 2, wherein: the adjusting includes adjusting the parameters according to one of a Gompertz function, a logistic function, a hyperbolic tangent function, an arctangent function, a hyperbolic tangent function, an arctangent function, a Gudermannian function, an error function, a generalized logistic function, a smoothstep function, and an algebraic function.

4. The method of claim 1, wherein: the determining the initial valid path includes applying one of an A* algorithm and a Dijkstra algorithm between the starting position and the ending position.

5. The method of claim 1, further comprising: navigating a robot along the piecewise Sigmoid curve path.

6. The method of claim 1, further comprising: obtaining a map of an environment including the starting position, the ending position, and at least one obstacle between the starting position and the ending position.

7. A computer program that is executable by a computer to cause the computer to perform operations comprising:
determining an initial valid path for guiding a robot from a starting position to an ending position;
dividing the initial valid path into a plurality of individual segments of the initial valid path; and
fitting a separate Sigmoid curve respectively to each of the plurality of individual segments of the initial valid path based on parameters of at least one of smoothness and security to produce a piecewise Sigmoid curve path.

8. The computer program of claim 7, wherein: the fitting includes adjusting a curve height parameter, a curve start position parameter, a curve sharpness parameter, or a length parameter of each Sigmoid curve.

9. The computer program of claim 8, wherein: the adjusting includes adjusting the parameters according to one of a Gompertz function, a logistic function, a hyperbolic tangent function, an arctangent function, a hyperbolic tangent function, an arctangent function, a Gudermannian function, an error function, a generalized logistic function, a smoothstep function, and an algebraic function.

10. The computer program of claim 7, wherein: the determining the initial valid path includes applying one of an A* algorithm and a Dijkstra algorithm between the starting position and the ending position.

11. The computer program of claim 7, further comprising: navigating a robot along the piecewise Sigmoid curve path.

12. The computer program of claim 7, further comprising: obtaining a map of an environment including the starting position, the ending position, and at least one obstacle between the starting position and the ending position.

13. An apparatus comprising:
an initial path determining section configured to determine an initial valid path for guiding a robot from a starting position to an ending position;
an initial path dividing section configured to divide the initial valid path into a plurality of individual segments of the initial valid path; and
a Sigmoid curve fitting section configured to fit a separate Sigmoid curve respectively to each of the plurality of individual segments of the initial valid path based on parameters of at least one of smoothness and security to produce a piecewise Sigmoid curve path.

14. The apparatus of claim 13, wherein: the Sigmoid curve fitting section includes an adjusting section configured to adjust a curve height parameter, a curve start position parameter, a curve sharpness parameter, or a length parameter of each Sigmoid curve.

15. The apparatus of claim 14, wherein: the adjusting section is further configured to adjust the parameters according to one of a Gompertz function, a logistic function, a hyperbolic tangent function, an arctangent function, a hyperbolic tangent function, an arctangent function, a Gudermannian function, an error function, a generalized logistic function, a smoothstep function, and an algebraic function.

16. The apparatus of claim 13, wherein: the initial valid path determining section applies one of an A* algorithm and a Dijkstra algorithm between the starting position and the ending position.

17. The apparatus of claims 13, further comprising: a robot navigating section configured to navigate a robot along the piecewise Sigmoid curve path.

18. The apparatus of claim 13, further comprising: an obtaining section configured to obtain a map of an environment including the starting position, the ending position, and at least one obstacle between the starting position and the ending position.
